(19) United States
(12) Patent Application Publication
(10) Pub. No.: US 2017/0054154 A1
(43) Pub. Date: Feb. 23, 2017

(54) CATALYST FOR FUEL CELL AND MANUFACTURING METHOD THEREOF

(71) Applicant: National Taiwan University of Science and Technology, Taipei (TW)

(72) Inventors: Chen-Hao Wang, New Taipei City (TW); Hsin-Chih Huang, Taoyuan City (TW); Kai-Chin Wang, Changhua County (TW); Yu-Chuan Lin, Taichung City (TW)

(21) Appl. No.: 14/932,971

(22) Filed: Nov. 5, 2015

(30) Foreign Application Priority Data
Aug. 17, 2015 (TW) 104126671

(51) Int. Cl. H01M 4/90

(52) U.S. Cl. CPC H01M 4/9083; H01M 4/9041

(57) ABSTRACT

A catalyst for a fuel cell and a manufacturing method thereof are provided. The manufacturing method includes the following steps. A first mixture is mixed with a solvent to form a mixture solution, wherein the first mixture includes a nitrogen-containing precursor, a sulfur-containing precursor, a non-noble metal-containing precursor, and a carbon support. The solvent in the mixture solution is removed to form a second mixture. A thermal treatment is performed on the second mixture.

### CROSS-REFERENCE TO RELATED APPLICATION

This application claims the priority benefit of Taiwan application serial no. 104126671, filed on Aug. 17, 2015. The entirety of the above-mentioned patent application is hereby incorporated by reference herein and made a part of this specification.

### BACKGROUND OF THE INVENTION

Field of the Invention

The invention relates to a catalyst and a manufacturing method thereof, and more particularly, to a catalyst for a fuel cell and a manufacturing method thereof.

Description of Related Art

A fuel cell is basically an electrochemical power-generation apparatus converting chemical energy into electrical energy via a redox reaction. In the common proton-exchange membrane fuel cell (PEMFC), methanol or hydrogen undergoes an oxidation reaction at an anode, and oxygen undergoes an oxygen-reduction reaction (ORR) at a cathode.

In general, since the reduction reaction of the cathode is slower than the oxidation reaction of the anode, a noble metal (such as platinum) is used as a cathode catalyst to increase the speed of the reduction reaction. Moreover, the known cathode catalyst is generally synthesized by mixing the precursor of a noble metal and an organic matter, and then performing pyrolysis at a temperature of 300° C. to 1200° C. for 4 hours to 8 hours. Therefore, the synthesis of a cathode catalyst requires a large amount of time and energy. Moreover, the synthesis of a cathode catalyst generally adopts a toxic solvent causing environmental pollution such as dimethylformamide (DMF) or chloroform, and is therefore not environment-friendly.

The known catalyst for a fuel cell is, for instance, a more expensive catalyst such as a platinum/carbon (Pt/C) catalyst, a pyrolyzed Vitamin B12/carbon catalyst published in Energy Environ. Sci., 2012, 5, 5305-5314 by Chen et al., a pyrolyzed tetramethoxy-phenyl porphyrin cobalt (II)/carbon catalyst published in Energy Environ. Sci., 2012, 5, 5305-5314 by Chen et al., a pyrolyzed cobalt/carbon and pyrolyzed iron phthalocyanine catalyst, or a pyrolyzed cobalt-Carlo/carbon catalyst published in Adv. Funct. Mater. 2012, 22, 3500-3508 by Chen et al. Therefore, how to develop a catalyst for a fuel cell without significantly increasing manufacturing costs is one current focus for those skilled in the art.

### SUMMARY OF THE INVENTION

The invention provides a manufacturing method of a catalyst for a fuel cell capable of reducing manufacturing costs and shortening manufacturing time.

The invention provides a catalyst for a fuel cell, including a carbon support, a nitrogen-containing metal compound, and a sulfur-containing metal compound. The manufacturing costs of the catalyst are lower, the manufacturing time of the catalyst is shorter, and the catalyst has a good ORR activity.

The manufacturing method of the catalyst for a fuel cell of the invention includes the following steps. A first mixture is mixed with a solvent to form a mixture solution, wherein the first mixture includes a nitrogen-containing precursor, a sulfur-containing precursor, a non-noble metal-containing precursor, and a carbon support. The solvent in the mixture solution is removed to form a second mixture. A thermal treatment is performed on the second mixture.

In an embodiment of the invention, the nitrogen-containing precursor includes melamine, urea, polyaniline, polypyrrole, or a combination thereof.

In an embodiment of the invention, the sulfur-containing precursor includes lipoic acid, carbon disulfide, or a combination thereof.

In an embodiment of the invention, the non-noble metal-containing precursor includes an iron-containing precursor, a cobalt-containing precursor, or a combination thereof.

In an embodiment of the invention, the thermal treatment is performed in a high-temperature furnace.

The catalyst for a fuel cell of the invention includes a carbon support, a nitrogen-containing metal compound, and a sulfur-containing metal compound. In particular, the nitrogen-containing metal compound, the sulfur-containing metal compound, and the carbon support form the catalyst for a fuel cell with the carbon support as the skeleton.

In an embodiment of the invention, the content ratio of nitrogen and sulfur of the catalyst is between 4:1 and 1:2.

In an embodiment of the invention, the metals in the nitrogen-containing metal compound and the sulfur-containing metal compound respectively include iron, cobalt, or a combination thereof.

In an embodiment of the invention, the nitrogen-containing metal compound includes iron nitride (Fe₃N), cobalt nitride (CoN), or a combination thereof.

In an embodiment of the invention, the sulfur-containing metal compound includes ferric sulfide (FeS), cobalt sulfide (CoS), or a combination thereof.

Based on the above, in the invention, the first mixture formed by the nitrogen-containing precursor, the sulfur-containing precursor, the non-noble metal-containing precursor, and the carbon support is mixed with the solvent to form the mixture solution, and then a thermal treatment is performed on the second mixture formed by removing the solvent in the mixture solution to form the catalyst. Accordingly, not only can raw material costs of the catalyst be significantly reduced and the manufacturing time of the catalyst for a fuel cell be shortened, the catalyst further has the advantage of readily controlled composition ratio.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic of the manufacturing process of a catalyst according to an embodiment of the invention.

FIG. 2 shows X-ray powder diffraction patterns of catalysts manufactured according to experimental examples and comparative examples of the invention.

FIG. 3 and FIG. 4 are the ORR curves of catalysts manufactured according to experimental examples and comparative examples of the invention.

### DESCRIPTION OF THE EMBODIMENTS

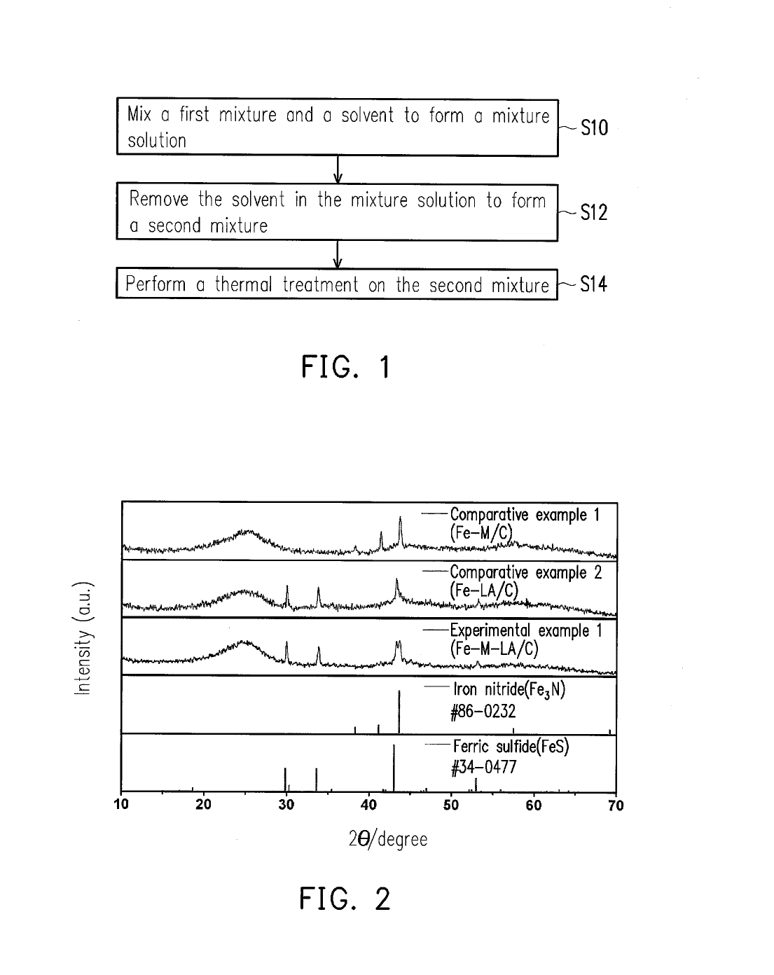

FIG. 1 is a schematic of the manufacturing process of a catalyst according to an embodiment of the invention. Referring to FIG. 1, a manufacturing method of a catalyst for a fuel cell can include the following steps: a first mixture and a solvent are mixed to form a mixture solution, wherein the first mixture includes a nitrogen-containing precursor, a sulfur-containing precursor, a non-noble metal-containing precursor, and a carbon support (step S10); the solvent in the mixture solution is removed to form a second mixture (step S12); and a thermal treatment is performed on the second mixture (step S14). Each of the steps above is described in detail in the following.

First, in step S10, a first mixture and a solvent are mixed to form a mixture solution. The first mixture includes a nitrogen-containing precursor, a sulfur-containing precursor, a non-noble metal-containing precursor, and a carbon support. The nitrogen-containing precursor is, for instance, melamine, urea, polyaniline, polypyrrole, or a combination thereof. The sulfur-containing precursor is, for instance, lipoic acid, carbon disulfide, or a combination thereof.

It should be mentioned that, the catalyst of the invention is composed of the nitrogen-containing precursor and the sulfur-containing precursor, and the content ratio of nitrogen and sulfur in the catalyst can be 4:1 to 1:2, preferably 2:1. However, the invention is not limited thereto.

The non-noble metal-containing precursor is, for instance, an iron-containing precursor, a cobalt-containing precursor, or a combination thereof. The iron-containing precursor (i.e., precursor of iron ion) can refer to any precursor capable of generating iron ions. Specifically, the iron-containing precursor includes ferric nitrate, potassium ferricyanide, ferric chloride, ferric sulfate, ferric fluoride, ferric bromide, ferric oxide, or a combination of the precursors. The cobalt-containing precursor (i.e., precursor of cobalt ion) can refer to any precursor capable of generating cobalt ions. Specifically, the cobalt-containing precursor includes cobalt nitrate, cobalt bromide, cobalt iodide, cobalt chloride, cobalt oxide, cobalt sulfate, cobalt phosphate, or a combination of the precursors.

It should be mentioned that, since the nitrogen-containing precursor, the sulfur-containing precursor, and the non-noble metal-containing precursor are relatively cheaper in comparison to the catalyst traditionally manufactured from platinum, the manufacturing costs of the catalyst can be significantly reduced.

The carbon support includes graphite, carbon clothes, fullerene, graphene, carbon nanotube (CNT), or a combination thereof.

The solvent refers to a solvent capable of dissolving the nitrogen-containing precursor, the sulfur-containing precursor, and the non-noble metal-containing precursor but does not react with the nitrogen-containing precursor, the sulfur-containing precursor, and the non-noble metal-containing precursor. More specifically, the solvent can be an alcohol solvent or water, both of which are environment-friendly.

The alcohol solvent can include monohydric alcohol. The monohydric alcohol includes, for instance, methanol, ethanol, n-propanol, isopropanol, n-butanol, sec-butanol, tert-butanol, isobutanol, n-hexanol, n-heptanol, n-octanol, or n-decanol. The solvent can be used alone or in combination. Moreover, a preferred solvent is ethanol, water, or a combination thereof. However, the invention is not limited thereto.

The method of mixing the first mixture and the solvent can be performed by any known mixing method. In the mixture solution after mixing, the first mixture is dispersed in the solvent. In an embodiment, the mixing method includes, for instance, performing stirring and mixing by using a magnetic stirrer or a mechanical stirrer. In another embodiment, ultrasound oscillation mixing can be performed by using a sonicator. The mixing method can be used alone or in multiple combinations, and a preferred mixing method includes performing ultrasonic oscillation mixing by using a sonicator to more uniformly disperse the first mixture in the solvent. However, the invention is not limited thereto. In an embodiment, the first mixture and the solvent are uniformly mixed by oscillating for 30 minutes by using a sonicator.

Then, in step S12, the solvent in the mixture solution formed in step S10 is removed to form a second mixture. The method of removing the solvent in the mixture solution is, for instance, a reduced-pressure concentration method, but the invention is not limited thereto.

It should be mentioned that, in step S12, since the nitrogen-containing precursor, the sulfur-containing precursor, and the non-noble metal-containing precursor are dispersed in the solvent, in the second mixture formed by removing the solvent of the mixture solution, the nitrogen-containing precursor, the sulfur-containing precursor, and the non-noble metal-containing precursor can be substantially uniformly dispersed on the carbon support.

Lastly, in step S14, a thermal treatment is performed on the second mixture to form a catalyst. The thermal treatment is, for instance, performed in a high-temperature furnace. The temperature of the thermal treatment is, for instance, between 500° C. and 900° C., and is preferably 700° C. However, the invention is not limited thereto. The time of the thermal treatment is, for instance, between 1 hour and 4 hours. In an embodiment, the second mixture can be placed in a container (such as a ceramic crucible or an aluminum oxide crucible, etc) and calcinated in a high-temperature furnace at different temperatures (500° C. to 900° C.), and then the temperature is held for 2 hours to form the catalyst.

The catalyst manufactured according to the above manufacturing method includes a carbon support, a nitrogen-containing metal compound, and a sulfur-containing metal compound, wherein the nitrogen-containing metal compound, the sulfur-containing metal compound, and the carbon support form the catalyst for a fuel cell with the carbon support as the skeleton. The metals in the nitrogen-containing metal compound and the sulfur-containing metal compound respectively include iron, cobalt, or a combination thereof. In an embodiment, the nitrogen-containing metal compound is iron nitride, cobalt nitride, or a combination thereof. In an embodiment, the sulfur-containing metal compound is ferric sulfide, cobalt sulfide, or a combination thereof. In an embodiment, the content ratio of nitrogen and sulfur in the catalyst is between 4:1 and 1:2.

### Experiment 1

### Experimental Example 1

First, melamine (nitrogen-containing precursor), lipoic acid (sulfur-containing precursor), ferric chloride (non-noble metal-containing precursor), and carbon black (model:Vulcan XC-72R) (carbon support) were mixed to form a first mixture, then ethanol (solvent) was added in the first mixture, and then mixing by oscillation was performed in a sonicator for 30 minutes to form a mixture solution. Then, reduced-pressure concentration was performed on the mixture solution in a rotary concentrator to remove the solvent (i.e., ethanol) in the mixture solution and form a second mixture. Lastly, the second mixture was placed in an aluminum oxide crucible, and calcination was performed in a high-temperature furnace (about 700° C.), and then the temperature was held for 2 hours to obtain an iron-melamine-lipoic acid/carbon (Fe-M-LA/C) catalyst.

### Comparative Example 1

The catalyst manufacturing method of comparative example 1 is similar to that of experimental example 1, and the difference is that the first mixture of comparative example 1 does not include lipoic acid (sulfur-containing precursor). Therefore, the formed catalyst is an iron-melamine/carbon (Fe-M/C) catalyst.

### Comparative Example 2

The catalyst manufacturing method of comparative example 2 is similar to that of experimental example 1, and the difference is that the first mixture of comparative example 2 does not include melamine (nitrogen-containing precursor). Therefore, the formed catalyst is an iron-lipoic acid/carbon (Fe-LA/C) catalyst.

In experimental example 1, an iron-ion precursor, melamine, lipoic acid, and a carbon support were used in the manufacture. The Fe-M-LA/C catalyst is a structure in which iron is the center, N and S are ligand groups, and a cyclic carbon support is the skeleton. Overall, the Fe-M-LA/C catalyst has a nitrogen-containing macrocyclic structure, and has active endpoints of metal-nitrogen-carbon (M-N—C) and metal-sulfur-carbon (M-S—C), wherein the active endpoints have oxygen-reduction activity. Moreover, in an oxygen-reduction reaction, the Fe-M-LA/C catalyst can reduce oxygen to water via the transfer of four electrons.

Material Properties of Catalyst

The X-ray powder diffraction of each of experimental example 1 (Fe-M-LA/C catalyst), comparative example 1 (Fe-M/C catalyst), and comparative example 2 (Fe-LA/C catalyst) was measured, wherein the model of the X-ray powder diffraction instrument was D2 phaser made by Bruker, and the light source wave length was 1.54056 angstroms.

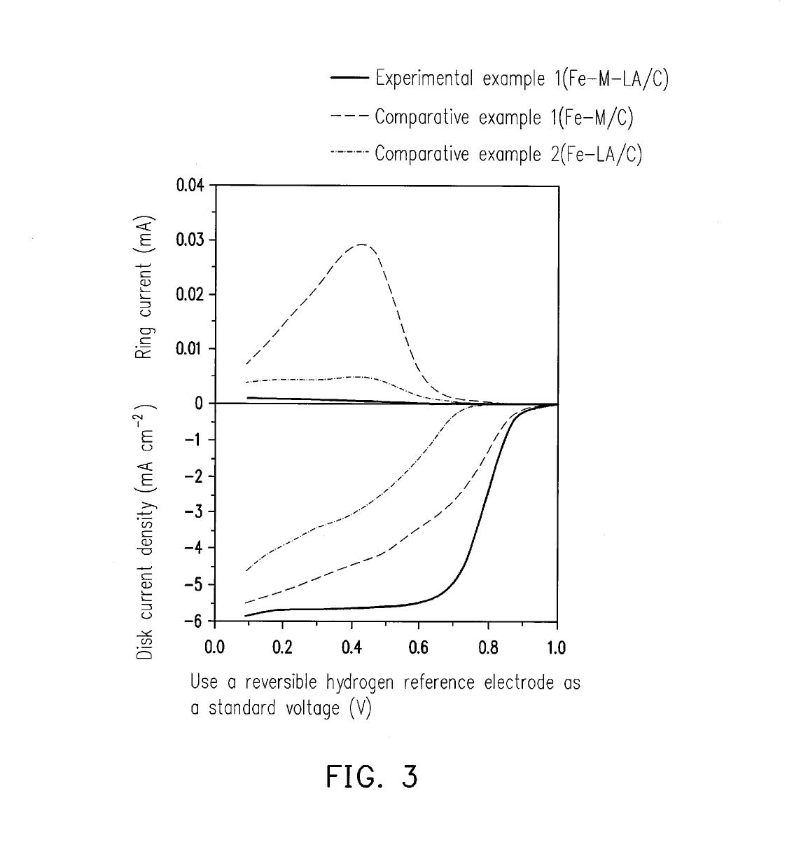

FIG. 2 shows X-ray powder diffraction patterns of catalysts manufactured in experimental examples and comparative examples. It can be known from the X-ray diffraction database that the characteristic peaks at 38.294, 41.216, and 43.706 degrees are from iron nitride, wherein the X-ray database number of iron nitride is #86-0232. It can be known from the X-ray diffraction database that the characteristic peaks at 29.943, 33.693, 43.181, and 53.169 degrees are from ferric sulfide, wherein the X-ray database number of ferric sulfide is #34-0477.

It can be known from the results of FIG. 2 that, the Fe-M/C catalyst manufactured in comparative example 1 has characteristic peaks at 38.294, 41.216, and 43.706 degrees from iron nitride. In other words, the Fe-M/C catalyst in comparative example 1 includes iron nitride. The Fe-LA/C catalyst manufactured in comparative example 2 has characteristic peaks at 29.943, 33.693, 43.181, and 53.169 degrees from ferric sulfide. In other words, the Fe-LA/C catalyst in comparative example 2 includes ferric sulfide. The Fe-M-LA/C catalyst manufactured in experimental example 1 has both a characteristic peak at 43.706 degrees from iron nitride and characteristic peaks at 29.943, 33.693, 43.181, and 53.169 degrees of ferric sulfide. In other words, the Fe-M-LA/C catalyst in experimental example 1 includes both iron nitride and ferric sulfide. It can therefore be known that, the nitrogen-containing precursor and the sulfur-containing precursor do not bond with each other in the reaction, and instead respectively bond with an iron-containing precursor (non-noble metal-containing precursor) to generate iron nitride and ferric sulfide.

The non-noble metal-containing precursor in the experimental examples and the comparative examples is exemplified by an iron-containing precursor, but the invention is not limited thereto. The non-noble metal-containing precursor can also adopt a cobalt-containing precursor, and therefore the obtained catalyst can be cobalt nitride, cobalt sulfide, or a combination thereof.

Measuring Method of ORR Activity of Catalyst

The measuring method of the ORR activity of the catalyst is as follows: a linear sweep voltammetry method was performed by using a rotating ring disk electrode in an O₂-saturated 0.1 M potassium hydroxide solution. The electric potential is represented by an RHE (reversible hydrogen electrode), and has a value of 0.1 V to 1.0 V. The reference electrode is a saturated calomel electrode (SCE, Hg/Hg₂Cl₂/KCl). A measuring instrument was used as a potentiostat (model: VSP, made by Biologic).

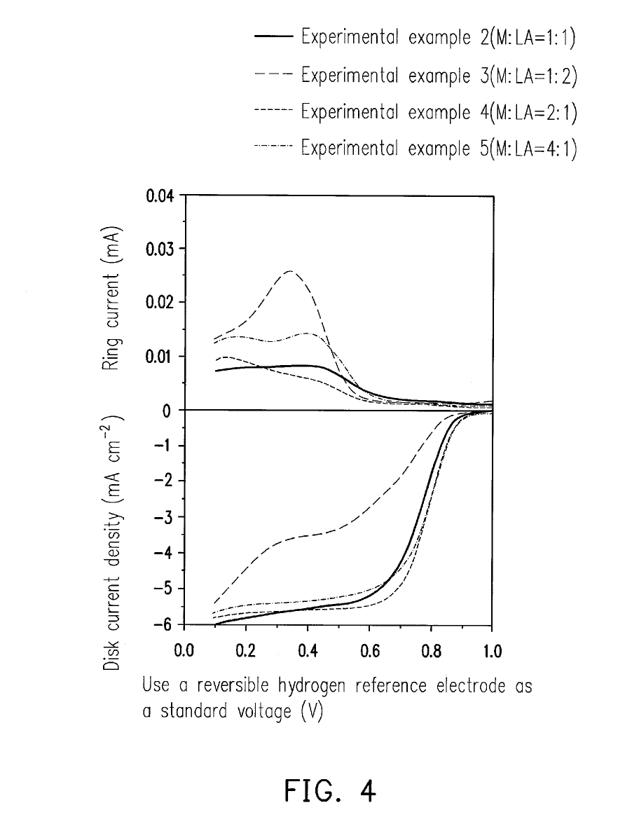

FIG. 3 is the ORR (oxygen-reduction reaction) curves of catalysts manufactured in experimental examples and comparative examples. The measurement results are as shown in FIG. 3. Specifically, FIG. 3 shows a curve of disk current density (I_{d}) to applied voltage and a curve of ring current (Iᵣ) to applied voltage, wherein saturated calomel electrode is used as the control standard for the applied voltage, and then the applied voltage is converted such that an RHE is used as the reference voltage so as to facilitate comparison with other reference literature. According to FIG. 3, the maximum value of the absolute value of the disk current density (I_{d}) and the minimum value of the absolute value of the ring current (Iᵣ) are used to calculate the total electron transfer number n via formula (1), and reaction intermediate product yield (% HO₂⁻) is calculated via formula (2). In formula (1) and formula (2), N represents the collection efficiency of a rotating ring disk electrode, and has a value of 0.368.

$$\begin{matrix}n = \frac{4 {I}_{D}}{{I}_{D} + ( {I}_{R} / N )} & formula ( 1 ) \\ \% {HO}_{2}^{-} = \frac{100 ( 4 - n )}{2} & formula ( 2 )\end{matrix}$$

A greater total electron transfer number n calculated via formula (1) represents better oxygen-reduction efficiency of the catalyst. A greater reaction intermediate product yield (% HO₂⁻) represents a greater amount of reaction intermediate product reduced from oxygen by the catalyst, which is undesirable. The total electron transfer number n and the reaction intermediate product yield (% HO₂⁻) of the catalysts manufactured by different compositions are as shown in Table 1. It can be known from Table 1 that, the total electron transfer number n of the Fe-M-LA/C catalyst manufactured in experimental example 1 is largest, and the reaction intermediate product yield (% HO₂⁻) thereof is smallest, which is due to the Fe-M-LA/C catalyst having both the structures of iron nitride and ferric sulfide. Moreover, a synergistic effect was generated, thus improving the ORR activity of the Fe-M-LA/C catalyst.

TABLE 1

| | | |
|---|---|---|
| | | Reaction |
| | Total electron | intermediate |
| | transfer | product yield |
| Catalyst composition | number n | (% HO₂⁻) |

| | | | |
|---|---|---|---|
| Experimental | Fe-M-LA/C | 3.994 | 0.280% |
| example 1 | | | |
| Comparative | Fe-M/C | 3.798 | 10.092% |
| example 1 | | | |
| Comparative | Fe-LA/C | 3.942 | 2.865% |
| example 2 | | | |

### Experiment 2

### Experimental Example 2 to Experimental Example 5

The catalyst manufacturing methods of experimental example 2 to experimental example 5 are the same as that of experimental example 1, wherein the weights of ferric chloride (non-noble metal-containing precursor) and carbon black (carbon support) are fixed, and the weight ratio of melamine (nitrogen-containing precursor) and lipoic acid (sulfur-containing precursor) is adjusted. Therefore, the content ratios of nitrogen and sulfur of the formed Fe-M-LA/C catalysts are respectively 1:1, 1:2, 2:1, and 4:1.

FIG. 4 is the ORR curves of catalysts manufactured in experimental example 2 to experimental example 5. The ORR activity of the catalysts manufactured in experimental example 2 to experimental example 5 was measured according to the ORR activity measuring method, and the measurement results are as shown in FIG. 4. Then, the total electron transfer number and the reaction intermediate product yield of the ORR activity of the catalysts can be obtained according to the calculation of formula (1) and formula (2). The total electron transfer number n and the reaction intermediate product yield (% HO₂⁻) of the Fe-M-LA/C catalysts having different content ratios of nitrogen and sulfur are as shown in Table 2. It can be known from Table 2 that, the total electron transfer number n of the Fe-M-LAIC catalyst having a content ratio of nitrogen and sulfur of 2:1 manufactured in experimental example 4 is largest, and the reaction intermediate product yield (% HO₂⁻) thereof is smallest, and therefore the ORR activity thereof is best.

TABLE 2

| | | |
|---|---|---|
| Catalyst | | |
| composition | Total | Reaction |
| (content ratio | electron | intermediate |
| of nitrogen | transfer | product yield |
| and sulfur) | number n | (% HO₂⁻) |

| | | | |
|---|---|---|---|
| Experimental | 1:1 | 3.993 | 0.328% |
| example 2 | | | |
| Experimental | 1:2 | 3.970 | 1.497% |
| example 3 | | | |
| Experimental | 2:1 | 3.994 | 0.280% |
| example 4 | | | |
| Experimental | 4:1 | 3.988 | 0.553% |
| example 5 | | | |

Based on the above, in the invention, the first mixture formed by the nitrogen-containing precursor, the sulfur-containing precursor, the non-noble metal-containing precursor, and the carbon support is mixed with the solvent to form the mixture solution, and then a thermal treatment is performed on the second mixture formed by removing the solvent in the mixture solution to form the catalyst. Accordingly, not only can raw material costs of the catalyst be significantly reduced and the manufacturing time of the catalyst for a fuel cell be shortened, the catalyst further has the advantage of readily controlled composition ratio. Moreover, the catalyst for a fuel cell manufactured according to the above method also has a good ORR activity.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A manufacturing method of a catalyst for a fuel cell, comprising:
mixing a first mixture with a solvent to form a mixture solution, wherein the first mixture comprises a nitrogen-containing precursor, a sulfur-containing precursor, a non-noble metal-containing precursor, and a carbon support;
removing the solvent in the mixture solution to form a second mixture; and
performing a thermal treatment on the second mixture.

2. The manufacturing method of a catalyst for a fuel cell of claim 1, wherein the nitrogen-containing precursor comprises melamine, urea, polyaniline, polypyrrole, or a combination thereof.

3. The manufacturing method of a catalyst for a fuel cell of claim 1, wherein the sulfur-containing precursor comprises lipoic acid, carbon disulfide, or a combination thereof.

4. The manufacturing method of a catalyst for a fuel cell of claim 1, wherein the non-noble metal-containing precursor comprises an iron-containing precursor, a cobalt-containing precursor, or a combination thereof.

5. The manufacturing method of a catalyst for a fuel cell of claim 1, wherein the thermal treatment is performed in a high-temperature furnace.

6. A catalyst for a fuel cell, comprising:
a carbon support; and
a nitrogen-containing metal compound and a sulfur-containing metal compound,
wherein the nitrogen-containing metal compound, the sulfur-containing metal compound, and the carbon support form the catalyst for a fuel cell with the carbon support as a skeleton.

7. The catalyst for a fuel cell of claim 6, wherein a content ratio of nitrogen and sulfur is between 4:1 and 1:2.

8. The catalyst for a fuel cell of claim 6, wherein metals in the nitrogen-containing metal compound and the sulfur-containing metal compound respectively comprise iron, cobalt, or a combination thereof.

9. The catalyst for a fuel cell of claim 6, wherein the nitrogen-containing metal compound comprises iron nitride (Fe₃N), cobalt nitride (CoN), or a combination thereof.

10. The catalyst for a fuel cell of claim 6, wherein the sulfur-containing metal compound comprises ferric sulfide (FeS), cobalt sulfide (CoS), or a combination thereof.
